(19) United States
(12) Patent Application Publication
(10) Pub. No.: US 2015/0225971 A1
(43) Pub. Date: Aug. 13, 2015

(54) ADJUSTABLE MOUNTING ARRANGEMENT

(71) Applicant: Bart's Ltd, Harbour City (HK)

(72) Inventor: Shane Gill, Beauty Point (AU)

(21) Appl. No.: 14/695,514

(22) Filed: Apr. 24, 2015

Related U.S. Application Data
(63) Continuation of application No. PCT/AU2013/001241, filed on Oct. 25, 2013.

(30) Foreign Application Priority Data
Oct. 25, 2012 (AU) 2012904661

(51) Int. Cl. E04G 21/32; F16B 2/08; E04G 21/24; F16M 13/02

(52) U.S. Cl. CPC E04G 21/32; F16M 13/022; F16B 2/08; E04G 21/24

(57) ABSTRACT

A mounting arrangement for a barricade and/or guarding system comprising at least one binding element, which in use, fastens around a mounting body, and at least one connector body connected to the at least one binding element, the connector body having at least one joiner engagement formation for connection to a joiner element. The binding element includes an elongate member having at least a fastening end, and at least one lengthwise side that includes an engagement arrangement, and a binding head connected to the elongate member, the binding head being spaced apart from the fastening end along the length of the elongate member and including a fastening opening for receiving the fastening end of the elongate member, the fastening opening including at least one fastening arrangement configured to cooperate with the engagement arrangement of the elongate member to lock a portion of the elongate member within the fastening opening.

### TECHNICAL FIELD

The present invention relates to a mounting arrangement, and a safety barricade and/or guarding system using that mounting arrangement. More specifically, the present invention can be used as part of a safety barricade system that is installed around the perimeter of a building or structure, elevated walkways or platforms and used during or after construction in order to prevent objects from falling from the building or structure. The present invention can also be used in guarding applications to protect operators from moving components and other hazards of machinery and equipment, in particular industrial machinery and equipment.

### BACKGROUND TO THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Scaffolding is required in many construction scenarios to provide a safe working platform for working at a height. However, scaffolding usually consists of a series of interconnected horizontal and vertical rails that leaves significant space between the scaffold rails and poles. Similarly, elevated walkways and platforms may include a barrier and railing that leaves significant gaps. Tools or building materials may therefore inadvertently pass through a gap or space and fall to a lower level or the ground, endangering workers on the site.

Shade cloth is used on some construction and mining sites as a barrier over and around gaps between support poles and railings. However, existing shade cloth can be time consuming to install, and may not have sufficient strength to withstand forces generated by some falling objects. Furthermore, existing shade cloth and other temporary construction screening can be difficult and/or time consuming to install on non-linear, curved surfaces, or areas and surfaces having abnormal geometry.

A number of safety barricade systems have been recently proposed which use connectors, such as clevis type clips and/or clamps to fix mesh panel barriers over and around gaps between support poles and railings around elevated walkways and platforms, scaffolding, and around industrial machinery. One example is described in the Applicant's international patent application PCT/AU2011/001165 and Australian Innovation Patent No. 2012101377. However, these forms of clips and clamps used to mount the mesh panels are generally configured to fit a specific shape and dimension of mounting body, for example a pole or railing. The mesh panel may be required to be installed onto a structure having mounting points of a large variety of dimensions and shapes. Existing systems would require a large variety of complementary sizes and configurations of clips and/or clamps to fit those mounting points, thereby adding to the complexity of the system.

It would therefore be desirable to provide an improved and/or alternative mounting arrangement for a barricade, and/or guarding system.

### SUMMARY OF THE INVENTION

In a first aspect, the present invention provides a mounting arrangement for a barricade and/or guarding system, the mounting arrangement comprising:

at least one binding element, which in use, fastens around a mounting body, the binding element comprising:
an elongate member having at least a fastening end, and at least one lengthwise side that includes an engagement arrangement; and
a binding head connected to the elongate member, the binding head being spaced apart from the fastening end along the length of the elongate member and including a fastening opening for receiving the fastening end of the elongate member, the fastening opening including at least one fastening arrangement configured to cooperate with the engagement arrangement of the elongate member to lock a portion of the elongate member within the fastening opening; and

at least one connector body mountable to the at least one binding element. In particular embodiments, the connector body includes at least two spaced apart binding element engagement formations adapted to receive and mount the connector body onto two separate binding elements or cooperative sets of binding elements; at least one joiner engagement formation for pivotable connection to a joiner element; and at least two mounting sides located on opposite sides of the connector body configured to abut the mounting body, each mounting side including a mounting channel configured to cooperate with the shape of a selected mounting body, the two mounting sides having different mounting channel configurations.

The mounting arrangement of the present invention therefore utilises one or an interconnected set of binding elements to mount a connector body around a mounting body, such as a pole, rail, beam, post or foot. The connector body is mounted on the elongate member of a binding element or a set of binding elements, the binding element(s) are then located around the mounting body and fastened together using the fastening arrangement of the binding head to mount the mounting arrangement thereon. The flexibility and adjustability provided by the binding element enables the mounting arrangement to be mounted and fastened around a large variety of shapes and sizes of mounting bodies and installation configurations including (but not limited to) round, square, rectangular, angle iron sections, universal beams, universal columns, plates (for example kick plates) and/or flat bars.

The binding elements may be integrally formed with the connector block or separately formed. Where the connector block and binding elements are separately formed, the members are preferably releasably connectable with the connector block. However, it should be appreciated in some embodiments, the binding elements could be connected using plastic welding, adhesive, moulding or the like. In some embodiments, each connector body includes at least one binding element engagement formation adapted to receive and mount the connector body onto the binding element.

The binding element(s) can comprise any suitable form. In preferred embodiments, the binding elements comprise binding straps or bands.

Any number of binding elements can be used to mount the connector body to the mounting body. In some embodiments, the mounting arrangement can include at least two binding elements for mounting around the mounting body. The fastening body is mounted on at least one of the binding elements, with the elongate members and the binding heads of the respective binding elements being cooperatively interconnected to extend and fasten around the mounting body. Any number of binding elements may be cooperatively interconnected. In some instances, two interconnected members may be sufficient to extend around a mounting body. In other instances, three, four or five interconnected binding elements may be required. In a preferred embodiment, the mounting arrangement includes four binding elements cooperatively interconnected around the mounting body. The four binding elements can be arranged to provide the sides of a four sided polygon to enclose around a selected mounting body.

The engagement arrangement of the binding element can have any suitable formation, including teeth, beads, tracks, apertures, grooves channels or the like. In a preferred embodiment, the engagement arrangement comprises at least one tooth, and more preferably at least two teeth. The teeth are preferably arranged in a longitudinal track along the elongate length of the binding element.

The binding element can have any length selected to fit around a selected mounting body. Mounting bodies can vary in dimensions from small diameter shafts to large diameter columns. In a preferred form, the binding element and elongate member and/or a cooperative arrangement of binding elements thereof is sized to fit sizes having a mean diameter from 10 mm to 1000 mm, preferably from 10 mm to 500 mm, more preferably from 20 mm to 350 mm.

The fastening arrangement of the binding head can include at least one resilient member extending from an inner surface of the opening, and an abutment surface adjacent to the resilient member. In use, the resilient member engages with at least one of the engagement arrangement of the elongate member when a portion of the elongate member is inserted into the fastening opening thereby securing said portion of the elongate member between at least one of the resilient members and the abutment surface.

The resilient member can have any suitable configuration. In one embodiment, the resilient member comprises a generally rectangular body. The resilient member is generally configured to engage and interlock with the engagement arrangement of an elongate member. Some resilient members can include an engagement surface having a substantially complementary configuration to the engagement arrangement of the elongate member. Where the engagement arrangement comprises teeth, the engagement surface has a complementary configuration to the teeth. Preferably, the engagement surface includes a portion which is generally perpendicular to the length of the elongate member configured to abut a complementary surface of the teeth of the elongate member to resist lengthwise movement of the elongate member in a direction away from the opening. In some embodiments, the engagement surface is located at a free end of the resilient members. Where the teeth of the elongate member have a sloped surface, each of the free ends of the resilient members can include a complementary sloped surface.

The fastening arrangement preferably comprises a unidirectional fastening arrangement configured to engage with at the engagement arrangement of the elongate member. Where the engagement arrangement comprise teeth, the resilient member of unidirectional fastening arrangement embodiments is preferably configured as a pawl, which, in use, engages with at least one of the teeth when the elongate member has been inserted through the opening. This type of pawl type fastening arrangement is used in a number of existing cable tie type binding head arrangements and provides a strong uni-directional lock between the teeth on an elongate member and the pawl.

The fastening opening can have any suitable configuration. The fastening opening is generally a through-hole in the binding head through which the elongate member can be threaded to allow the size of a loop formed by the elongate member to be adjustable. The fastening opening can be orientated within the binding head in any desired direction. In some embodiments, the fastening opening is orientated along an axis which is generally perpendicular to the longitudinal length of the elongate member. In other embodiments, the fastening opening is orientated along an axis which is generally parallel to the longitudinal length of the elongate member.

In some embodiments, the binding head includes two fastening openings. In these embodiments, a first fastening opening is preferably orientated along an axis which is generally perpendicular to the longitudinal length of the elongate member. A second fastening opening is preferably orientated along an axis which is generally parallel to the longitudinal length of the elongate member. Each fastening opening includes a fastening arrangement. The first fastening opening enables connection with an elongate member generally perpendicular to the longitudinal length of the elongate member. The second fastening opening enables connection with an elongate member generally parallel to the longitudinal length of the elongate member.

In some embodiments, the engagement arrangement preferably comprises a plurality of ratchet teeth arranged as a track substantially along the length of the elongate member. The resilient member can therefore be configured to abut at least one of the ratchet teeth in the track. The resilient members can be configured to substantially mate with each of the engagement surfaces where the ratchet teeth includes a first engagement surface generally acutely angled to the length of the elongate member and a second engagement surface generally perpendicular to the length of the elongate member.

The engagement arrangement of one or each side of the elongate member can have the form of a track having a shape that is generally directionally arranged relative to the fastening end of the elongate member. The directionally arranged engagement arrangement(s) are preferably configured to directionally cooperate with the unidirectional fastening arrangement of the fastening arrangement. Where the engagement arrangement comprises ratchet teeth, the teeth on one side of the elongate member can include a sloped surface which is oriented towards the fastening end of the elongate member. Where the elongate member has engagement arrangements on two sides, it is preferred that the engagement arrangement of each side of the elongate member is arranged as a track orientated in the same direction. However, it should be appreciated that some embodiments may have the different tracks orientated in different directions.

In some embodiments, the elongate member includes two, opposing lengthwise sides, each side having an engagement arrangement. The fastening opening preferably includes two fastening arrangements arranged on opposing surfaces. Each fastening arrangement is configured to cooperate with at least one engagement arrangement to lock a portion of the elongate member within the fastening opening.

In some embodiments, the fastening opening extends through the binding head between a fastening side and a stop side. In such embodiments, the elongate member can further include a plurality of spaced apart stop formations on a lengthwise side. Each stop formation includes a ramped side and a stop side. The ramped side is preferably orientated on that lengthwise side facing the fastening side of fastening opening when the fastening end is inserted into the fastening opening. The stop side is configured to, in use, abut a surface of the stop side of the binding head after egressing the fastening opening. This forms a secondary stop formation to the fastening arrangement, where the stop side of the stop formations engage a surface of the stop side of the binding head to resist the elongate member being pulled backwards through the binding head from the stop side to the fastening side.

The connector body can comprise any element, mount or component which interconnects the binding elements and a joiner element. In one embodiment, the connector body comprises a connector block. However, it should be appreciated that various other shapes and configurations are possible.

The connector body interconnects with the binding elements through the binding element engagement formation(s). The binding element engagement formation can comprise any formation which releasably engages with the binding element and more preferably the elongate member of the binding element. The binding element engagement formation can comprise any connection configuration through which a mounting member can be received. In some embodiments, the binding element engagement formation comprises at least one aperture, passage, slot, slit, loop, groove, clasp, clip, hook, or channel. In a preferred embodiment, each binding element engagement formation comprises an aperture, preferably configured as a slot, through which the elongate member can be received.

The connector body preferably includes at least two spaced apart binding element engagement formations adapted to receive and mount the connector body onto two separate binding elements or cooperative sets of binding elements. In some embodiments, the binding element engagement formations are spaced apart about and around the joiner engagement formation. In other embodiments, where the connector body includes two or more second connector formations, one or more of the first connector formations can be aligned with one or more of the second connector formations.

The binding element engagement formations are preferably aligned at least one of longitudinal or laterally through the connector body. In some embodiments, the connector body include at least one longitudinally aligned binding element engagement formation. In some embodiments, the connector body include at least one laterally aligned binding element engagement formation. In some embodiments, the connector body include at least one longitudinally aligned binding element engagement formation and at least one laterally binding element engagement formation. Where the binding element engagement formations include apertures, channels or the like, it is preferred that the apertures, channels or the like are longitudinal or laterally aligned through the connector body as described above.

In some embodiments, the connector body can includes a plurality of aligned binding element engagement formations. The binding element engagement formations are typically axially aligned through the thickness or height of the connector body, to provide a degree of mounting adjustability for the binding elements. Any number of aligned binding element engagement formations can be included in the connector body, such as two, three, four, five, or ten. In one embodiment, four laterally stacked binding element engagement formations are provided.

The connector body preferably includes at least one mounting side configured to abut the mounting body. Each mounting side includes a mounting channel configured to cooperate with the shape of the mounting body. The cooperative profile of the mounting channel is envisaged to be able to be tailored to match any required profile. Examples of cooperative profile of the mounting channel include at least one of a curved, square, rectangular, triangular, pentagonal or octagonal cooperative profile. Each mounting side preferably includes at least one joiner engagement formation. In some embodiments, each mounting side preferably includes at least two joiner engagement formations. In one embodiment, each mounting side includes three joiner engagement formations.

Some embodiments may include a connector body with two mounting sides, located on opposite sides of the connector body. Each mounting side preferably has a different shaped mounting profile. For example, in one embodiment, the first mounting side includes a mounting channel having a curved cooperative profile and the second mounting side includes a mounting channel having a rectangular shaped cooperative profile.

In some embodiments, the connector body includes at least one passage aligned with at least one of the joiner engagement formations, that joiner engagement formation extending to the passage. It is preferred for the joiner engagement formation is aligned with and extends between the mounting channel and the passage. The passage can comprise any aperture, channel, hole or opening including one or more of the binding element engagement formations.

The joiner engagement formation can comprise any suitable connection structure which cooperates with a complementary connection structure on the joiner element. In some embodiments, the joiner engagement formation comprises at least one of an aperture, recess, groove, rod, clip, hook, loop or similar. In a preferred embodiment, the joiner engagement formation comprises an aperture.

In some embodiments, the connector body further includes at least one fastener engagement formation for receiving a fastener. The connector body preferably includes at least two, and more preferably four fastener engagement formations spaced around the connector body. In one embodiment, the fastener body includes a connector fastener engagement formation at each corner of the body. The fastener engagement formation can be configured to receive any suitable fastener. In one preferred embodiment, the fastener engagement formation comprises an aperture. The aperture is preferably configured to receive a bolt, screw, rivet or nail.

The joiner element can comprise any fastener, clip, peg, joiner or the like which can be utilised in cooperation with the mounting body to attach another element, such as a panel, to the mounting arrangement. In some embodiments, the joiner element comprises a bolt which screws or is otherwise releasably engaged within the joiner engagement formation. In one preferred embodiment, the joiner element comprises a joiner element having a first engagement formation located on a first side, and a second engagement formation located on an opposing second, the first engagement formation being adapted to engage the joiner engagement formation to secure the joiner element to the clip. The joiner element also comprises a stopper element having a third engagement formation, the third engagement formation being engageable with the second engagement formation to secure the stopper element to the joiner element.

In some embodiments, the first engagement formation is rotatable relative to the joiner engagement formation. The first engagement formation is also preferably eccentric relative to the second engagement formation. This configuration enables the second engagement formation to rotate around the first engagement formation. This provides an element of adjustability which, in use, facilitates alignment of the second engagement formation with another element, such as an aperture of a mesh panel.

The joiner engagement formation preferably includes a first aperture, and the first engagement formation includes a first projection having a flange adapted to engage with the first aperture. The second engagement formation preferably includes a second projection, having a flange adapted to engage with a stopper element aperture formed in the stopper element.

The stopper element is preferably a generally circular disc. The third engagement formation preferably comprises a stopper element aperture located in a central region of the disc. The stopper element aperture is configured to receive and capture the second engagement formation.

In a second aspect, the present invention provides a barricade and/or guarding system comprising:

at least one mounting arrangement according to the first aspect of the invention;

at least one mesh panel;

wherein in use, a portion of the mesh panel is held in a joiner element fastened within the joiner engagement formation.

Some embodiments of the barricade system may further comprise a joiner assembly to secure adjacent sections of said mesh panel to one another. The joiner assembly preferably includes a body having a first longitudinally extending joiner channel and a second longitudinally extending joiner channel, the first and second longitudinally extending joiner channels each being adapted to receive an edge portion of said mesh panel.

In a third aspect, the present invention provides a method of installing a barricade and/or guarding system to a fixed structure, the method including the steps of:

securing at least one mounting arrangement according to the first aspect of the present invention to at least one mounting point of a fixed structure;

engaging an eccentric joiner element to the joiner engagement formation, the joiner element having a first engagement formation located on a first side, and a second engagement formation located on an opposing second, the first engagement formation being adapted to engage the joiner engagement formation to secure the joiner element to the mounting arrangement, the first engagement formation being eccentric relative to the second engagement formation, the joiner engagement formation being pivotally engaged with the first engagement formation;

placing a mesh panel adjacent to the joiner element;

rotating a body portion of the joiner element so that a second engagement formation formed on an opposing side of the joiner element relative to the first engagement formation becomes aligned with an aperture formed in the mesh panel; and

securing a stopper element onto the second engagement formation, the stopper having a third engagement formation adapted to engage with the second engagement formation to sandwich a portion of the mesh panel between the joiner element and the stopper element.

The barricade and/or guarding system to a fixed structure installed according to the third aspect of the present invention preferably comprises a system according to the second aspect of the present invention.

### BRIEF DESCRIPTION OF THE DRAWINGS

A preferred embodiment of the invention will now be described by way of specific examples with reference to the accompanying drawings, in which:

FIG. 1 is a front perspective view of a preferred embodiment of an adjustable mounting arrangement according to the present invention;

FIG. 2 is a side perspective view of the adjustable mounting arrangement shown in FIG. 1, attached to a vertical pole;

FIG. 3 provides a detailed perspective view of the binding head and configuration of a first embodiment of the elongate member used in the adjustable mounting arrangement shown in FIG. 1;

FIG. 4 and FIG. 5 provide detail of the fastening arrangement of the binding element of the adjustable mounting arrangement shown in FIG. 1;

FIG. 6 shows various fastening configurations using four binding elements from the adjustable mounting arrangement shown in FIG. 1;

FIG. 6A provides a perspective view of a second form of the elongate member which can be used with an adjustable mounting arrangement according to the present invention.

FIG. 7 provides a top perspective view of a first embodiment of the connector block of the adjustable mounting arrangement as shown in FIG. 1;

FIG. 8 provides a base perspective view of the connector block shown in FIG. 7;

FIG. 9 provides a perspective view of (A) an eccentric joiner; and (B) stopper which can be used with the adjustable mounting arrangement shown in FIG. 1;

FIG. 9A provides a top perspective view of a second embodiment of connector block which can be used in an adjustable mounting arrangement according to the present invention;

FIG. 9B provides a base perspective view of the connector block shown in FIG. 9A;

FIG. 10 shows various mounting body configurations that the of the adjustable mounting arrangement shown in FIG. 1 can be attached;

FIG. 11 shows the adjustable mounting arrangement shown in FIG. 1 used to attach a mesh panel to a railing structure; and

FIG. 12 shows the adjustable mounting arrangement shown in FIG. 1 used to attach a mesh panel underneath a stairway structure.

### DETAILED DESCRIPTION

FIGS. 1 to 10 illustrate an adjustable mounting arrangement 110 according to a preferred embodiment of the present invention which can be used to mount a barricade of guarding panel of a barricade and/or guarding system.

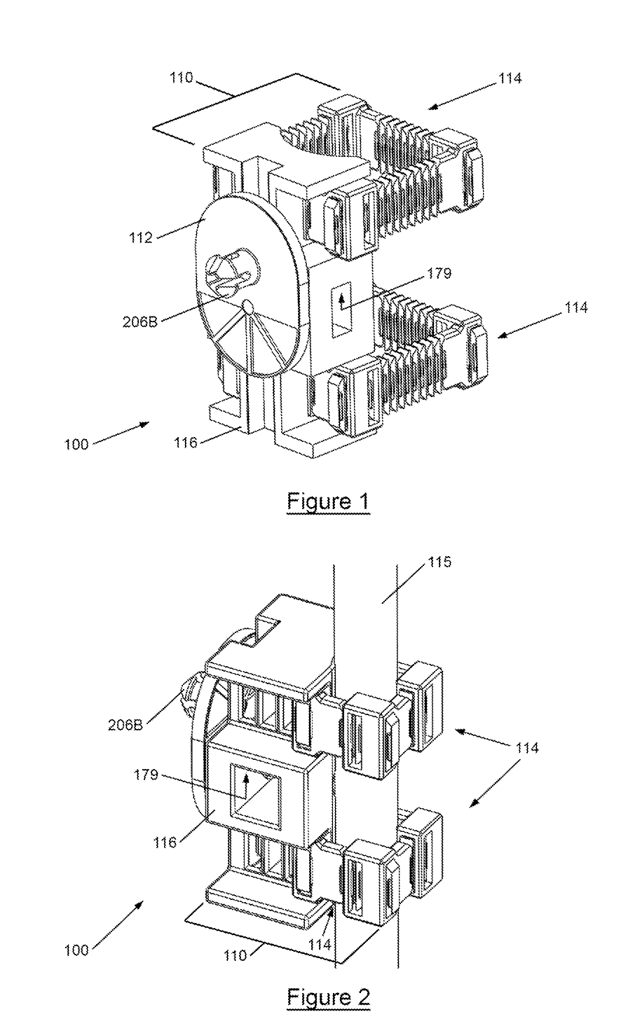

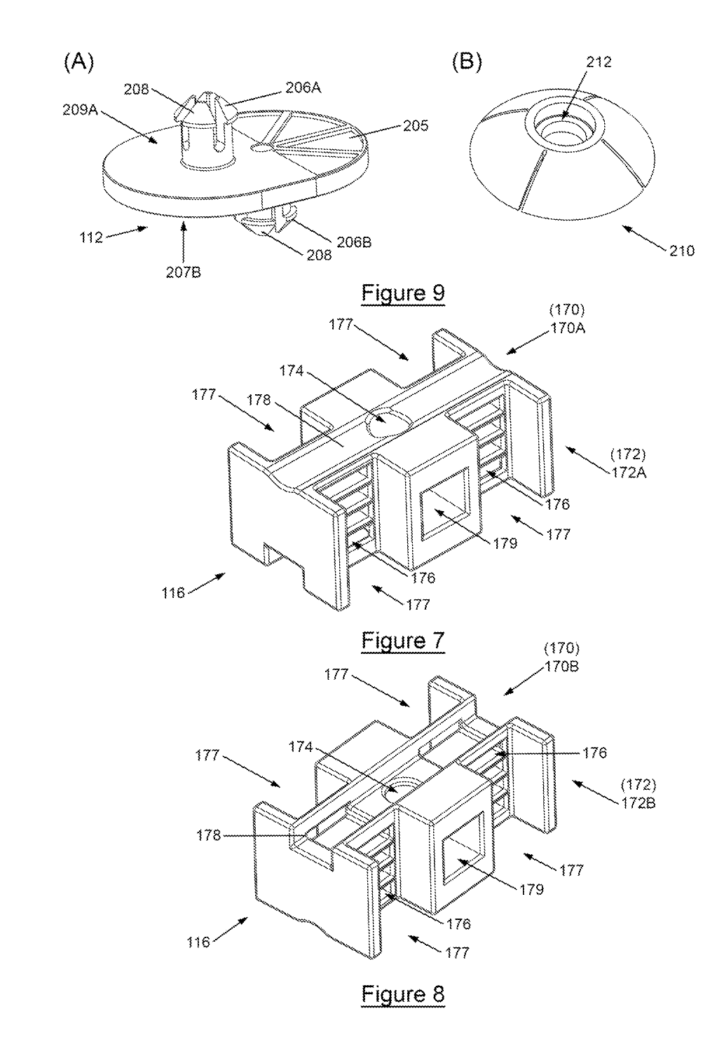

Referring generally to FIGS. 1 and 2, a panel fastening system 100 is shown comprising the mounting arrangement 110 and an attached eccentric joiner 112. The mounting arrangement 110 comprises an interconnected loop of binding elements 114 which, as shown in FIG. 2, can be fastened around a mounting body (in this case pole 115). The mounting arrangement 110 also comprises a connector block 116 which is connect to the binding elements 114 and includes a central fastening aperture (not shown in FIGS. 1 and 2, but shown as aperture 174 in FIGS. 7 and 8) which receives and connects the eccentric joiner 112.

It should be appreciated that the illustrated adjustable mounting arrangement 110 can be used as part of guarding systems on conveyors, actuators, rotating machinery and many more applications. The adjustable mounting arrangement 110 can also be used as part of barricading systems on platforms, stairways, stair risers, scaffolding and many more applications.

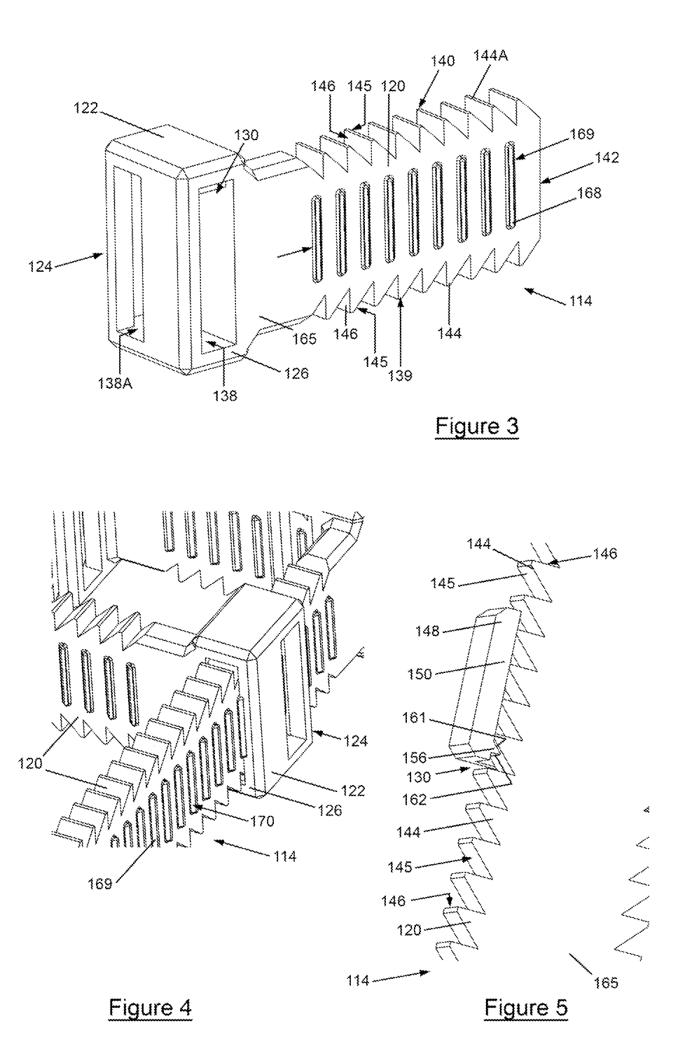

A first embodiment of the binding elements 114 is shown in detail in FIGS. 3 to 6. Each binding element 114 generally consists of an elongate strap 120 with an integrally connected binding head 122.

As best shown in FIG. 3, the binding head 122 is a substantially square plastic body having a fastening side 124 and a stop side 126. The fastening side 124 has a fastening opening 138 that extends through the binding head 122 to the stop side 126 along an axis orientated generally perpendicular to the longitudinal length of the elongate strap 120. This binding head 122 can be configured with a second fastening opening 138A orientated 90 degrees to the first fastening opening 138 including a second fastening arrangement (not illustrated). In the illustrated embodiment, that second fastening opening 138A could be used to longitudinally interconnect binding elements 114 to provide a greater combined member length.

Each fastening opening 138 can include a fastening arrangement 130 (explained in more detail below) configured to cooperate with teeth 144 and/or 144A of the elongate strap 120 to lock a portion of the elongate strap 120 within the fastening opening 138.

The elongate strap 120 is an elongate flat strip of plastic having two edge sides 139 and 140 and a free end, known as the fastening end 142. Each edge side 139 and 140 of the elongate strap 120 include a lengthwise track having a plurality of ratchet teeth 144 and 144A spaced along the length of each side of the elongate strap 120. Each of the ratchet teeth 144 of the first side 139 and second side 140 include a sloped surface 145 and stop face 146 that are directionally arranged along the length of the elongate strap 120, with the sloped surfaces 145 sloping in a direction towards the fastening end 42. The teeth 144 and 144A of the each side of the elongate strap 120 are configured for use with the fastening arrangement 130 located within the fastening opening 138.

The illustrated elongate straps 120 comprise a rigid polymer material, and therefore have only a small lateral flexibility. However, it should be appreciated that more flexible embodiments could be used within the scope of the present invention in which the elongate straps 120 could be bent or otherwise wrapped around a mounting body.

As best illustrated in FIGS. 3 and 5, the fastening opening 138 includes the fastening arrangement 130 comprising a uni-directional fastening arrangement 148 which cooperates with the engaging teeth 144 of either the first side 139 or second side 140 of the elongate strap 120 (depending on the orientation of the member 120) to lock a portion of the elongate strap 120 into the fastening opening 138. The illustrated fastening arrangement 148 includes a pawl 150 formed integrally with the internal wall of the fastening opening 138. The pawl 150 is resiliently biased to an engaged position (as shown) but may deflect through bending along its length. The pawl 150 includes a tooth 156 having a complementary shape to the shape of teeth 144 of the first side 139 and second side 140 of the elongate strap 120. In use, the fastening end 142 of the elongate strap 120 is inserted into the fastening opening 138 through the fastening side 124 to the stop side 126. During this action, the teeth 144 of the elongate strap 120 rides over the ramped backs 161 of the tooth 156 of pawl 150. Any attempt to withdraw the elongate strap 120 from the fastening opening 138 in the opposite direction causes the stop face 146 of the elongate strap 120 to engage with the complementary shaped face 162 of the pawl 150 and prevent retraction of the elongate strap 120.

Each broad lengthwise side 165 of the elongate strap 120 includes a series of spaced apart stop formations 168. Each stop formation 168 includes a ramped side 169 and a stop side 170. The ramped side 169 is orientated on the elongate strap 120 facing the fastening end 140 of that elongate strap 120. The stop side 170 is orientated on the elongate strap 120 facing the binding head 122 of that binding element 114. As shown in FIG. 4, in use, the stop side 170 of the stop formation 168 is configured to abut a surface of the edge stop side 126 of the binding head 122 after egressing the fastening opening 130. This forms a secondary stop formation to the fastening arrangement 148, where the stop side 170 of the stop formations 168 engage a surface of the stop side 170 of the binding head 122 to resist the elongate strap 120 being pulled backwards through the binding head 122 from the stop side 126 to the fastening side 124.

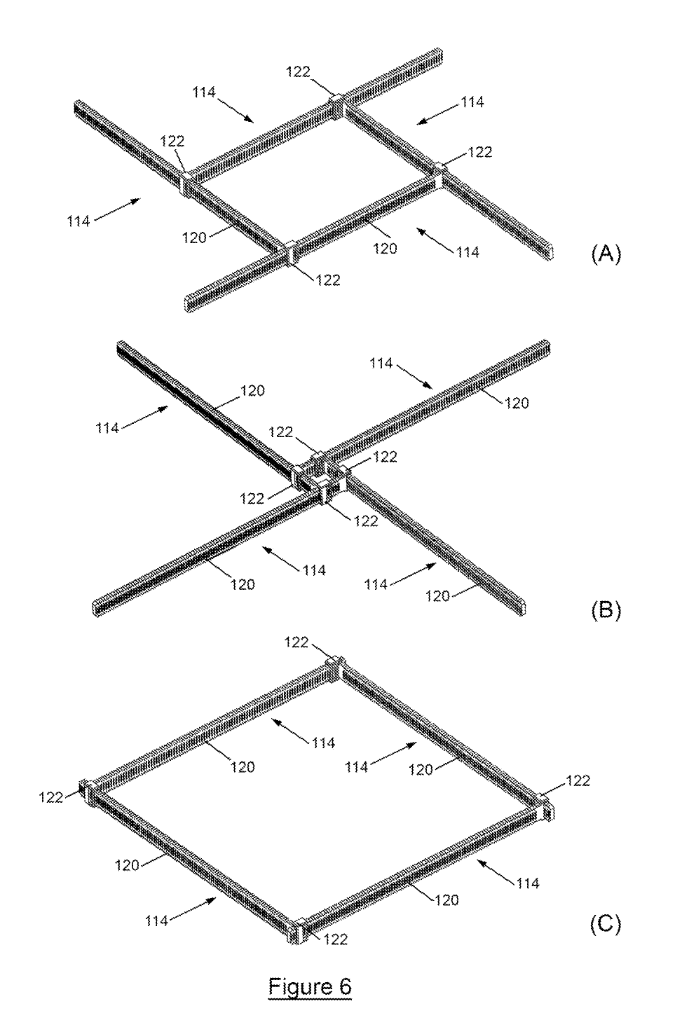

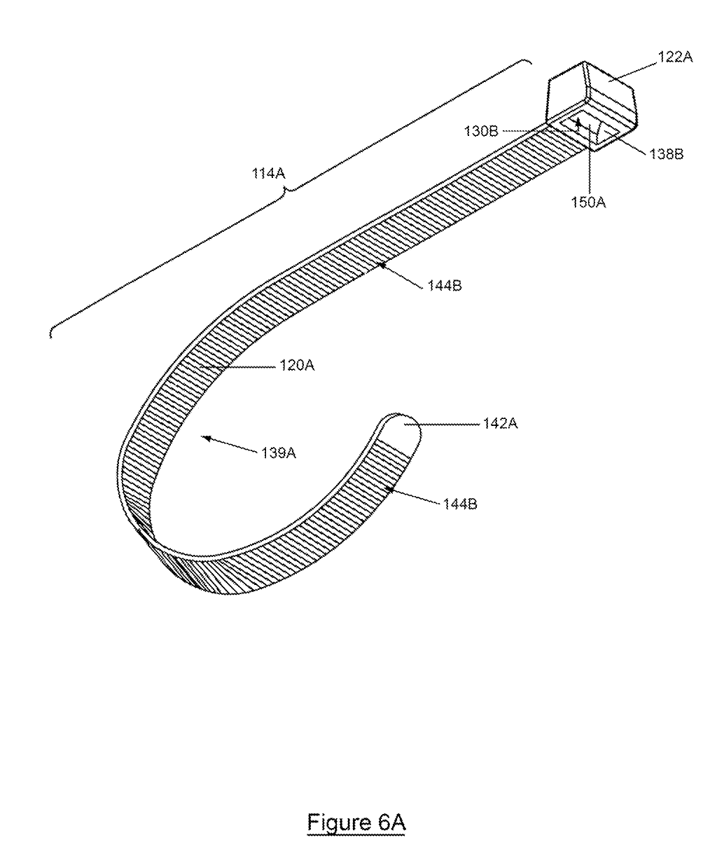

As shown in FIGS. 6A, 6B and 6C, the binding elements 114 can be cooperatively interconnected to form a generally square loop which can be adjusted in size to fasten around a selected mounting body. In FIG. 6, four binding elements 114 have been cooperatively interconnected by fastening a portion of an adjacent binding element into the first fastening opening 138 of the respective binding head 122. The position of the elongate strap 120 within the respective binding head 122 can be adjusted to provide a small loop ((B) in FIG. 6), wide loop ((C) of FIG. 6) or any size in between, for example the loop shown in (A) of FIG. 6. This adjustability enables this cooperative arrangement of binding elements 114 to be adjusted to fit around a selected mounting body varying in dimensions from small diameter shafts to large diameter columns. In a preferred form, the four cooperatively interconnected binding elements 114 are sized to fit sizes having a mean diameter from 20 mm to 350 mm.

A second embodiment of the binding element 114A is shown in detail in FIG. 6A. This binding element 114A substantially takes the form of a conventional cable tie. Again, each binding element 114A generally consists of an elongate strap 120A with an integrally connected binding head 122A.

Again, the binding head 122A is a substantially square plastic body having a fastening opening 138B that extends through the binding head 122A. The fastening opening 138B can include a fastening arrangement (not illustrated but explained in more detail below) configured to cooperate with teeth 144B of the elongate strap 120A to lock a portion of the elongate strap 120A within the fastening opening 138B.

The elongate strap 120A is an elongate flat strip of plastic having two sides 139A and 140A and a free end, known as the fastening end 142A. Each side 139A and 140A of the elongate strap 120A include a lengthwise track having a plurality of ratchet teeth 144B spaced along the length of each side of the elongate strap 120A. Each of the ratchet teeth 144B. The teeth 144B of the each side of the elongate strap 120A are configured for use with the fastening arrangement located within the fastening opening 138B.

The fastening arrangement 130 of the fastening opening 138B includes a pawl 150A formed integrally with the internal wall of the fastening opening 138B providing a uni-directional fastening arrangement. While not illustrated in FIG. 6A, it is to be appreciated that the pawl 150A includes a tooth or teeth having a complementary shape to the shape of teeth 144B of the elongate strap 120A. In use, the fastening end 142A of the elongate strap 120A is inserted into the fastening opening 138B, such that the teeth 144B of the elongate strap 120A ride over the tooth or teeth of pawl 150A. Any attempt to withdraw the elongate strap 120A from the fastening opening 138B in the opposite direction causes the teeth 144B of the elongate strap 120A to engage with the tooth or teeth of the pawl 150A and prevent retraction of the elongate strap 120A.

The illustrated elongate straps 120A comprise a flexible polymer material.

Again, these binding elements 114A can be cooperatively interconnected to form a loop which can be adjusted in size to fasten around a selected mounting body.

It should be appreciated that other configurations of binding elements could equally be used in the present invention. For example, other suitably sized cable tie configurations may be suitable in some applications.

As shown in FIGS. 1 and 2, the four cooperatively interconnected binding elements 114 are used to mount the connector block 116 to a mounting body, such as pole 115 in FIG. 2.

FIGS. 7 and 8 illustrate a first embodiment of the connector block 116, used in the adjustable mounting arrangement 110 shown in FIGS. 1 and 2. The illustrated connector block 116 comprises a generally rectangular block having four longitudinal faces 170, 172 which include two opposing sets of connector arrangements 174, 176 located on opposite sides of the connector block 116.

The two broad faces 170A and 170B of the connector block 116 comprise mounting faces for the connector block 116 which are configured to respectively abut against the abutting surface of a mounting body, and interconnect with a joiner element, such as eccentric joiner 112 through a central connection aperture 174 (FIGS. 7 and 8).

Each mounting face 172A, 172B includes a mounting channel 178 having a cooperative profile configured to cooperate with the shape of the mounting body. Each mounting face 170A and 170B has a different shaped cooperative profile. The mounting channel 178 of the first mounting side 170A (FIG. 7) has a curved cooperative profile. The mounting channel 178 of the second mounting side 170B (FIG. 8) has a rectangular shaped cooperative profile. Each of the profiles can be used to abut against a cooperatively shaped or sized mounting structure.

Examples of various mounting structures are shown in FIG. 10. In each example, four cooperatively interconnected binding elements 114 have been tightened around the mounting body to secure the connector block 116 to that mounting body.

FIG. 10A shows the connector block 116 mounted to a round pole 180. The second mounting face 170B is mounted abutting that pole 180.

FIG. 10B shows the connector block 116 mounted to a thin rectangular beam 181. The first mounting face 170A is mounted abutting that beam 181, with the beam 181 being of a size that can be received in the mounting channel 180.

FIG. 10C shows the connector block 116 mounted to a small square pole 182. The first mounting face 170A is mounted abutting that beam 181, with the beam 181 being of a size that can be received within and the mounting channel 180.

FIGS. 10D and 10E shows the connector block 116 mounted to a large square pole 183 and large I-beam 184. In each instance the mounting face of the pole 183 and beam 184 are wider than the body of the connector block 116. In these instances, the mounting face 170A or 170B used in not relevant as the mounting channel 180 cannot cooperate with the abutting mounting surface due to the size of the abutting mounting surface of the pole 183 and I-beam 184. Accordingly, either mounting face 170A or 170B could therefore be used to abut against that mounting body 183, 184.

Each broad faces 170A and 170B also includes a central connector aperture 174 used to interconnect with a joiner element, such as eccentric joiner 112 (detailed below). Each central connector aperture 174 extends through to a central passage 179 which extends through the connector block 116 from each of the side faces 172A and 172B.

The two side faces 172A and 172B also include a series of mounting slots 176 which are configured to receive and mount the connector block 116 onto the binding element 114 as shown in FIGS. 3 to 6. Each of the mounting slots 176 is positioned within recesses 177 in the connector block 116. The recesses 177 provide a narrowed width at the mounting slot positions in the connector block 116. It should be appreciated that other embodiments of the connector block 116 may not include such recesses 177. The mounting slots 176 are provided as a stack of four slots 176 grouped at two spaced apart locations at the respective ends of the connector block 116. As shown in FIGS. 1 and 2, each group of mounting slots 176 is designed to receive one binding element or set of members 114 enabling mount the connector block 116 to be mounted onto a mounting body using two separate binding elements 114 or cooperative sets of binding elements 114. The stacked set of mounting slots 176 provides a degree of mounting adjustability for the binding elements 114 when mounting the connector block 116 to a mounting body.

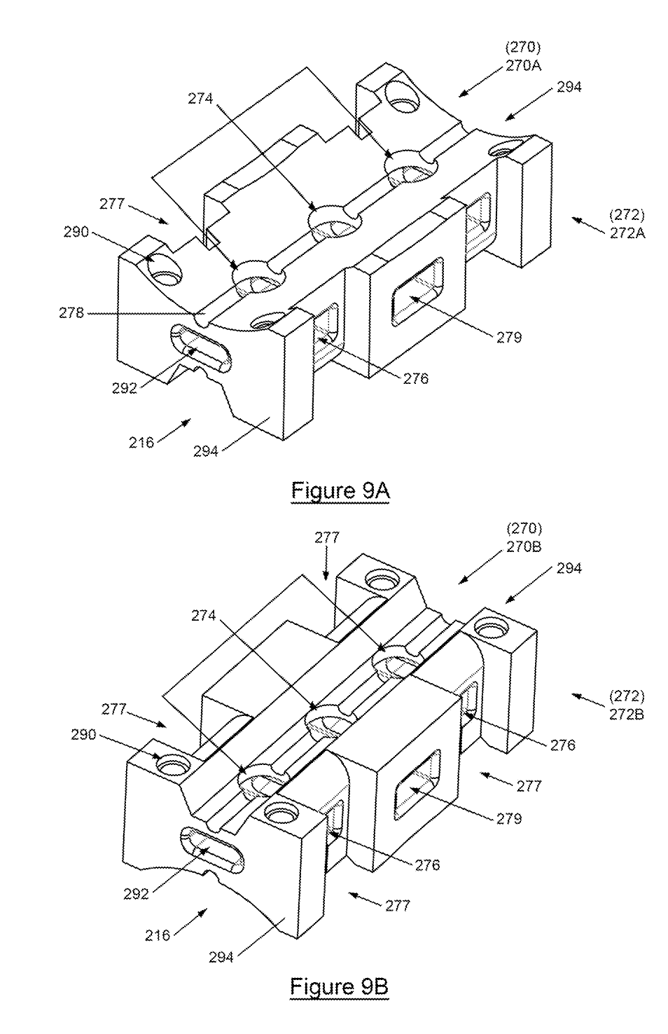

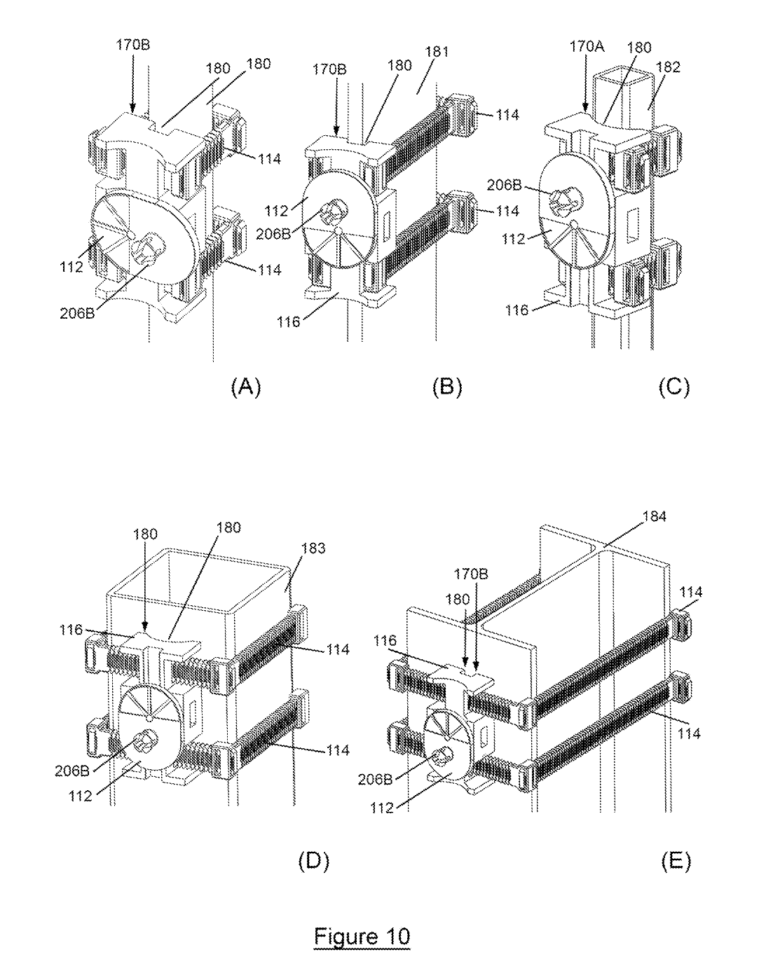

FIGS. 9A and 9B illustrate a second embodiment of the connector block 216 which can be used with a mounting arrangement according to the present invention. Like the first embodiment, the connector block 216 comprises a generally rectangular block having four longitudinal faces 270, 272 which include two opposing sets of connector arrangements 274, 276 located on opposite sides of the connector block 216.

The two broad faces 270A and 270B of the connector block 216 comprise mounting faces for the connector block 216 which are configured to respectively abut against the abutting surface of a mounting body, and interconnect with a joiner element, such as eccentric joiner 112 (FIG. 9) through a central connection aperture 274 (FIGS. 9A and 9B).

Again, each mounting face 272A, 272B includes a mounting channel 278 having a cooperative profile configured to cooperate with the shape of the mounting body. Again, each mounting face 270A and 270B has a different shaped cooperative profile. The mounting channel 278 of the first mounting side 270A (FIG. 9A) has a curved cooperative profile. The mounting channel 278 of the second mounting side 270B (FIG. 9B) has a frustoconical shaped cooperative profile. As explained above in relation the first embodiment of the connector block 116, each of the profiles can be used to abut against a cooperatively shaped or sized mounting structure.

Each broad faces 270A and 270B also includes three longitudinally aligned central connector aperture 274 used to interconnect with a joiner element, such as eccentric joiner 112 (detailed below). Each central connector aperture 274 extends through to a central passage 279, or one of the lateral mounting slots 276. Each of the respective central passage 279 and lateral mounting slots 276 extends through the connector block 216 from each of the side faces 272A and 272B.

The two side faces 272A and 272B also include lateral mounting slots 276 which are configured to receive and mount the connector block 216 onto a binding element 114 as shown in FIGS. 3 to 6. Each of the lateral mounting slots 276 is positioned within recesses 277 in the connector block 216. Again, the recesses 277 provide a narrowed width at the lateral mounting slot positions in the connector block 216. It should be appreciated that other embodiments of the connector block 216 may not include such recesses 277.

The connector block 216 also includes a longitudinal mounting slot 292 which extends between and through the longitudinal ends 294. The longitudinal mounting slot 292 is configured to receive and mount the connector block 216 onto a binding element 114 or 114A (for example illustrated in FIGS. 3 to 6A). This embodiment therefore enables the connector block 216 to be mounted longitudinally with respect to a mounting body. Selection of the lateral mounting slots 276 and/or longitudinal mounting slot 292 for use with a binding element 114 or 114A depends on the configuration of the mounting body.

The connector block 216 also includes four fastener apertures 290 located at each corner of the connector block 216. The fastener apertures 290 can be used to receive a fastener such as a screw, rivet, bolt or similar to mount the connector block 216 to a mounting body. These fasteners could be used as a secondary fastening arrangement for the connector block 216.

While the illustrated embodiments of connector block 116 and 216 illustrate the connector block 116 and 216 being releasably connected to the binding elements 114, 114A using slots 176 and 276 respectively, it should be appreciated that in other embodiments the members 114, 114A could be integrally formed or fixedly connected to the connector blocks 116 or 216. For example, the members could be integrally moulded with the connector blocks. Alternatively, the members 114, 114A could be plastic welded, screwed, fixed with adhesive or similar to the connector blocks 116 or 216.

The adjustable mounting arrangement 110 can utilise an eccentric joiner 112 and mesh stopper 210 to fasten a portion of a mesh panel to the mounting arrangement 110. As shown in FIGS. 7, 8, 9A and 9B, the connection apertures 174, 274 of the connector block 116 and 216 are provided to enable attachment of an eccentric joiner 112.

As best illustrated in FIG. 9, the illustrated eccentric joiner 112 comprises generally oval shaped body 205 having two projections 206A and 206B extending perpendicularly from each of the broad faces 207A and 207B of that body 205. The first projection 206A and the second projection 207B extend in opposite directions from the body 205 and are generally parallel and offset (eccentrically aligned) with respect to each other. The first projection 206A is not aligned with the second projection 206B.

Both the first projection 206A and the second projection 206B each include a circumferentially extending flange 208 for securement with the connector aperture 174 of connector block 116, or with a mesh stopper 210 shown in FIG. 9B, depicted in the form of a mesh clip button. The flanges 208 comprise one or more frustoconical portions, forming a flared, barbed head located at or near the end of the projections 206A, 206B. Each flange 208 also include a cross shaped split through its center to enable greater resilient compression of those flanges 208 when secured in or through the respective cooperative opening 174 or 212 in the connector block 116 or stopper 210 respectively. The flanges 208 enable the two parts to snap together, but inhibit subsequent separation of the two parts.

With reference to the first embodiment of the connector block 116 illustrated in FIGS. 7 and 8, when in use, first projection 206A or the second projection 206B is inserted into the connection aperture 174 of the connector block 116 with the distal end extending into the central passage 179. Circumferentially extending flange 208 is designed to extend through that connection aperture 174 and abut on and be captured at the edge of the opening of the connection aperture 174 within the central passage 179.

Similarly, in the second embodiment of the connector block 216 shown in FIGS. 9A and 9B, when in use, first projection 206A or the second projection 206B is inserted into one of the connection apertures 274 of the connector block 216 with the distal end extending into the central passage 279 or the respective lateral mounting slot 276. Circumferentially extending flange 208 is designed to extend through that connection aperture 274 and abut on and be captured at the edge of the respective opening of the connection aperture 274 within the central passage 279 or the lateral mounting slot 276.

It should be appreciated that once one of the projections 206A or 206B is received in the connection aperture 174 or 274 of the connector block 116 or 216, the eccentric joiner 112 is able to rotate about that connection. The unused projection 206A/206B is then able to rotate about a circle, relative to the other projection 206B/206A to provide a degree of positional adjustability for that other projection 206B/206A. As will be described below, this provides an advantage when mounting a mesh panel to the mounting arrangement 110, as the free projection can be positioned in alignment with a mesh aperture of the mesh panel.

The illustrated stopper 210 (FIG. 9) is a generally circular disc having a centrally formed connection aperture 212 which is used to attach the stopper 210 onto either the first projection 206A or the second projection 206B of the eccentric joiner 112.

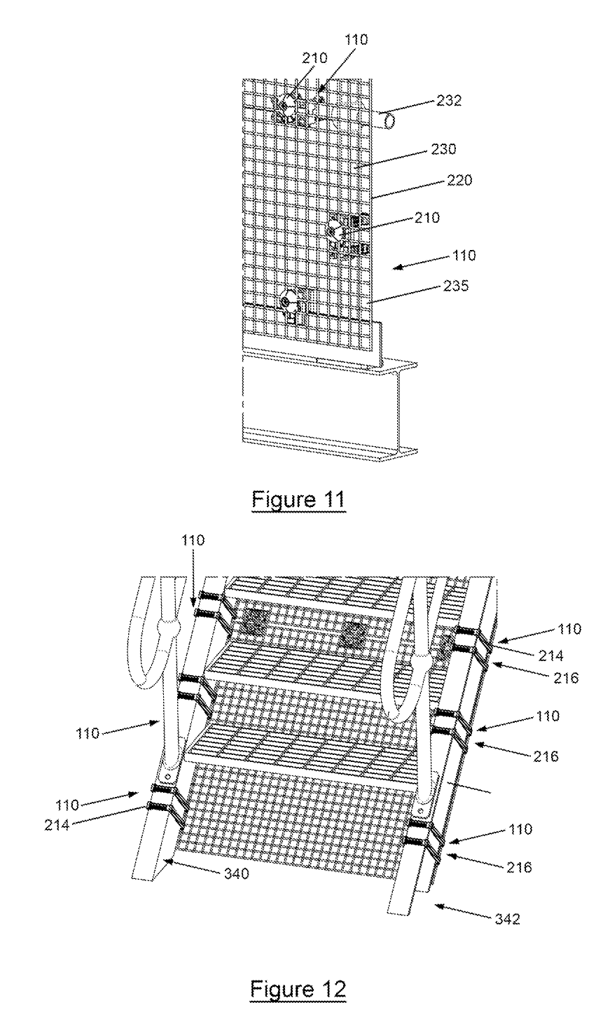

As shown in FIG. 11, the mesh stopper 210 and the eccentric joiner 112 are used to sandwich and secure a portion of a mesh panel 220 between the body of the eccentric joiner 112 and the stopper 210.

In this example, the connector arrangement 110 is mounted to a pole 230 or railing 232. Mounting is achieved by extending and interconnecting two sets of four mounting members 114 around a mounting position, mounting a connector block 116 onto those members through the mounting slots 176 and tightening the respective mounting members 114 around each mounting position. The first projection 206A of the eccentric joiner 112 is then snap fitted within the connector aperture 174 of the connector block 116. The second projection 206B of the eccentric joiner 112 is then aligned with and inserted through adjacent mesh apertures 235 of the mesh panel 220. If the apertures on the mesh panel 220 do not line up with the second projection 206B, one or more of the eccentric joiners 112 may be manually rotated. The eccentric nature of the eccentric joiner 112 enables the location of the second projection 206B to translate around an arc, circle or part thereof relative to (and centred about) the first projection 206A through rotation of the eccentric joiner 112 about the first projection 206A. The mesh panel 220 can be pushed into place when a suitable position is reached where the second projection 106B lines up with openings in the matrix of the mesh panel 220. The stopper 110 is snapped into engagement with the second projections 1068.

The stopper 210 is generally sized to be larger than the length and width of the apertures in the mesh panel 220, so the mesh panel 220 is unable to be unintentionally removed.

In the embodiment depicted in the drawings, the stopper 210 connects to the first projection 206A on account of the flared barb like head or flanges, as described above. However, it will be appreciated that the first projection 206A and stopper 210 may be connected with a set screw, grub screw or other fastener.

A mesh panel 220 could be similarly mounted on a construction site, machine guarding position, shielding or other desired application or location, using the adjustable mounting arrangement 110. For example, as shown in FIG. 12, a similar arrangement can be used for stairway guards, with the mounting arrangement 110 secured to the stringers 340 of the stairway 342.

The illustrated mounting arrangement 110 can form part of a safety barricade and/or guard system that includes at least one mesh panel and a plurality of mounting clips, including the mounting arrangement 110. An example of a safety barricade and/or guard system that can incorporate the present adjustable mounting arrangement 110 as a replacement for or in conjunction with the described mounting clips is described in the Applicant's international patent application PCT/AU2011/001165 and Australian Innovation Patent No. 2012101377, the contents of which should be understood to be incorporated into this specification by this reference.

The mounting arrangement 110 can therefore be used to secure a mesh panel to a support structure such as a scaffold post, the flange of a scaffold kick plate, or a support post, leg or arm of an industrial machine or equipment. In this respect, the mounting arrangement 110 enables a mesh panel to be secured to a wide range of fixed structural elements on a construction site, such as poles, posts, scaffold posts, handrails, middle rails, stanchion posts, stairway elements or the like.

The adjustable mounting arrangement 110, including connector block 116 and binding elements 114, and the eccentric joiner 112 and mesh stopper 210 and components thereof are preferably manufactured using a resilient material, such as a polymer/plastic material. It should be understood that a large number of polymers may be used, a number with selected polymer additives to enhance or provide specific desired properties. In addition, colorants may be added in the process to control the colour of the final part. Useful polymers include all thermoplastics, some thermosets, and some elastomers. More preferably, the polymer comprises at least one homopolymer, copolymer, blend or alloy including polycarbonate, polyvinyl chloride, or polyacrylonitrile. In some embodiments, the polymer is an impact modified and UV stabilised polymer. Exemplary examples include impact modified polycarbonate, acrylonitrile butadiene styrene (ABS) and blends thereof with polycarbide, styrene polycarbide blends, styrene maleic anhydride (SMA) and blends thereof with polycarbide, Styrene Methyl Methacrylate (S-MMA) and blends thereof with polycarbide, Acrylonitrile Ethylene Styrene (AES) and blends thereof with polycarbide, acrylonitrile styrene acrylate (ASA) and blends thereof with polycarbide, in particular an ASN polycarbide alloy. In an exemplary embodiment, the mesh panel is manufactured from Geloy HRA222F, Geloy HRA170D and/or UPVC.

With respect to the above description, it is to be realized that the optimum dimensional relationship for the various components of the adjustable mounting arrangement including variations in size, materials, shape, form, function, and the manner of operation, assembly and use, are deemed readily apparent and obvious to one skilled in the art, and all equivalent relationships to those illustrated in the drawings and described in the specification are intended to be encompassed by the invention.

The mounting arrangement and associated barricade system can be used on platforms, stairways, stair risers, scaffolding, elevated walkways, machine guarding as well as barricading and many more applications.

The mounting arrangement and associated barricade system is non heat conductive, anti-static, anti-corrosive, fire resistant, impact resistant, chemical resistant, UV Stabilised, non-conductive, and light weight.

The mounting arrangement and associated barricade system is reusable, and suits permanent or temporary installations.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A mounting arrangement for a barricade and/or guarding system, the mounting arrangement comprising:
at least one binding element, which in use, fastens around a mounting body, the binding element comprising:
an elongate member having at least a fastening end, and at least one lengthwise side that includes an engagement arrangement; and
a binding head connected to the elongate member, the binding head being spaced apart from the fastening end along the length of the elongate member and including a fastening opening for receiving the fastening end of the elongate member, the fastening opening including at least one fastening arrangement configured to cooperate with the engagement arrangement of the elongate member to lock a portion of the elongate member within the fastening opening; and
at least one connector body mountable to the at least one binding element, the connector body including:
at least two spaced apart binding element engagement formations adapted to receive and mount the connector body onto two separate binding elements or cooperative sets of binding elements;
at least one joiner engagement formation for pivotable connection to a joiner element; and
at least two mounting sides located on opposite sides of the connector body configured to abut the mounting body, each mounting side including a mounting channel configured to cooperate with the shape of a selected mounting body, the two mounting sides having different mounting channel configurations.

2-3. (canceled)

4. A mounting arrangement according to claim 1, wherein the connector body includes a plurality of aligned binding element engagement formations.

5. A mounting arrangement according to claim 1, wherein the binding element engagement formations comprise at least one aperture, preferably at least one slot, through which the elongate member can be received.

6. A mounting arrangement according to claim 1, in which the binding element engagement formation(s) are aligned as at least one of longitudinal or laterally through the connector body.

7. (canceled)

8. A mounting arrangement according to claim 1, wherein the mounting channel includes at least one of a curved, square, rectangular, triangular, pentagonal or octagonal cooperative profile.

9-10. (canceled)

11. A mounting arrangement according to claim 1, wherein the first mounting side includes a mounting channel having a curved cooperative profile and the second mounting side includes a mounting channel having a rectangular shaped cooperative profile.

12. A mounting arrangement according to claim 1, wherein each mounting side includes at least two joiner engagement formations.

13. A mounting arrangement according to claim 1, wherein the connector body includes at least one passage aligned with at least one of the joiner engagement formations, that joiner engagement formation extending to the passage.

14. A mounting arrangement according to claim 13, wherein the joiner engagement formation is aligned with and extends between the mounting channel and the passage.

15. A mounting arrangement according to claim 1, wherein the joiner engagement formation comprises an aperture.

16. A mounting arrangement according to claim 1, wherein the connector body further includes at least one fastener engagement formation for receiving a fastener.

17. A mounting arrangement according to claim 16, wherein the fastener engagement formation comprises an aperture.

18. A mounting arrangement according to claim 1, further comprising a joiner element which cooperates with the connector body, the joiner element comprising:
a joiner element having a first engagement formation located on a first side, and a second engagement formation located on an opposing second side, the first engagement formation being adapted to engage the joiner engagement formation to secure the joiner element to the mounting arrangement; and
a stopper element having a third engagement formation, the third engagement formation being engageable with the second engagement formation to secure the stopper element to the joiner element.

19. A mounting arrangement according to claim 18, wherein the joiner engagement formation is pivotally engaged with the first engagement formation and the first engagement formation is eccentric relative to the second engagement formation.

20. A mounting arrangement according to claim 18, wherein the joiner engagement formation includes a first aperture, the first engagement formation includes a first projection having a flange adapted to engage with the first aperture, and the second engagement formation includes a second projection, having a flange adapted to engage with a stopper element aperture formed in the stopper element.

21. A mounting arrangement according to claim 18, wherein the stopper element is a generally circular disc and the third engagement formation comprises a stopper element aperture located in a central region of the disc.

22. A mounting arrangement according to claim 1, wherein the mounting arrangement includes at least two binding elements for mounting around the mounting body, the fastening body being mounted on at least one of the binding elements, and wherein the elongate members and the binding heads of the respective binding elements being cooperatively interconnected to extend and fasten around the mounting body.

23. A mounting arrangement according to claim 22, wherein the mounting arrangement includes four binding elements cooperatively interconnected around the mounting body.

24. A mounting arrangement according to claim 1, wherein the binding element is sized to fasten around a mounting body having a mean diameter from 10 mm to 500 mm.

25. A mounting arrangement according to claim 1, wherein the fastening arrangement of the binding head includes at least one resilient member extending from an inner surface of the opening having an engagement surface, the engagement surface having a substantially complementary configuration to the engagement arrangement of the elongate member.

26. A mounting arrangement according to claim 1, wherein the fastening arrangement is a unidirectional fastening arrangement configured to engage with the engagement arrangement of the elongate member.

27. A mounting arrangement according to claim 1, wherein the engagement arrangement comprises at least one tooth, preferably at least two teeth.

28. A mounting arrangement according to claim 27, wherein the teeth comprise a plurality of ratchet teeth arranged as a track substantially along the length of the elongate member.

29. A mounting arrangement according to claim 1, wherein the fastening opening extends through the binding head between a fastening side and a stop side, and wherein the elongate member further includes a plurality of spaced apart stop formations on a lengthwise side, each stop formation including a ramped side and a stop side, wherein the ramped side is orientated on that lengthwise side facing the fastening side of fastening opening when the fastening end is inserted into the fastening opening, and the stop side is configured to, in use, abut a surface of the stop side of the binding head after egressing the fastening opening.

30-31. (canceled)

32. A barricade and/or machine guarding system comprising:
at least one mounting arrangement according to claim 1;
at least one mesh panel;
wherein in use, a portion of the mesh panel is held in a joiner element fastened within the joiner engagement formation.

33. A method of installing a barricade system and/or a machine guard to a fixed structure, the method including the steps of:
securing at least one mounting arrangement according to claim 1 to at least one mounting point of a fixed structure;
engaging an eccentric joiner element to the joiner engagement formation, the joiner element having a first engagement formation located on a first side, and a second engagement formation located on an opposing second, the first engagement formation being adapted to engage the joiner engagement formation to secure the joiner element to the mounting arrangement, the first engagement formation being eccentric relative to the second engagement formation, the joiner engagement formation being pivotally engaged with the first engagement formation;
placing a mesh panel adjacent to the joiner element;
rotating a body portion of the joiner element so that a second engagement formation formed on an opposing side of the joiner element relative to the first engagement formation becomes aligned with an aperture formed in the mesh panel; and
securing a stopper element onto the second engagement formation, the stopper having a third engagement formation adapted to engage with the second engagement formation to sandwich a portion of the mesh panel between the joiner element and the stopper element.

34. A method of installing a barricade system and/or a machine guard to a fixed structure according to claim 33, using a barricade system and/or a machine guard comprising: said at least one mounting arrangement; and at least one mesh panel; wherein in use, a portion of the mesh panel is held in a joiner element fastened within the joiner engagement formation.
